(19) United States
(12) Patent Application Publication
(10) Pub. No.: US 2007/0033816 A1
(43) Pub. Date: Feb. 15, 2007

(54) Rapid workpiece engraving apparatus

(75) Inventors: Fa-Hong Zeng, Shenzhen (CN); Wei Zhou, Shenzhen (CN); Chuang Liu, Shenzhen (CN); Liang-Jie You, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/453,459

(22) Filed: Jun. 14, 2006

(30) Foreign Application Priority Data
Aug. 12, 2005 (CN) 200510036593.8

(51) Int. Cl. B43L 13/00

(52) U.S. Cl. 33/18.1

(57) ABSTRACT

An engraving apparatus for engraving workpieces includes a sliding assembly (10), a cutting tool assembly (40), and a driving mechanism (30). The sliding assembly includes at least one rail (11) and at least two worktables (13). The worktables are used for carrying the workpieces, and are slidably positioned on the rail. The cutting tool assembly includes a cutter (43). The driving mechanism is used for driving the worktables and the cutting tool assembly.

### TECHNICAL FIELD

The present invention generally relates to engraving apparatuses and, more particularly, to an engraving apparatus capable of rapidly engraving multiple workpieces.

### BACKGROUND

Engraving apparatuses, such as laser engraving machines, are widely used to treat molds or create decorative patterns. Different marks or designs are often engraved onto surfaces using engraving apparatuses in order to create attractive features and patterns.

A typical numerical control engraving apparatus includes a cutting tool, a driving mechanism, and a sliding rail assembly. The driving mechanism has a driving motor. The slide rail assembly includes a rail and a slide table. The slide table can slidably move on the rail and thus be moved by the driving motor. When using the engraving apparatus, a workpiece is positioned on the slide table so that the cutting tool can be numerically controlled to engrave a desired mark or design on the workpiece as the slide table moves.

However, typical numerical control engraving apparatuses can only engrave one workpiece at a time as they only have one slide table, making them impractical for large-scale applications.

Therefore, an engraving apparatus which can overcome the above-described problems is desired.

### SUMMARY

In one embodiment thereof, an engraving apparatus for engraving workpieces includes a sliding assembly, a cutting tool assembly, and a driving mechanism. The sliding assembly includes at least one rail and at least two worktables. The worktables are used for carrying the workpieces, and are slidably positioned on the rail. The cutting tool assembly includes a cutter. The driving mechanism is used for driving the worktables and the cutting tool assembly.

Other advantages and novel features will become more apparent from the following detailed description when taken in conjunction with the accompanying drawings.

### BRIEF DESCRIPTION OF THE DRAWINGS

Many aspects of the engraving apparatus can be better understood with reference to the following drawings. The components in the drawings are not necessarily drawn to scale, the emphasis instead being placed upon clearly illustrating the principles of the present engraving apparatus. Moreover, in the drawings, like reference numerals designate corresponding parts throughout the several views.

FIG. 1 is a schematic front view of a engraving apparatus in accordance with a preferred embodiment; and

FIG. 2 is a schematic side view of the engraving apparatus in FIG. 1.

### DETAILED DESCRIPTION OF THE EMBODIMENT

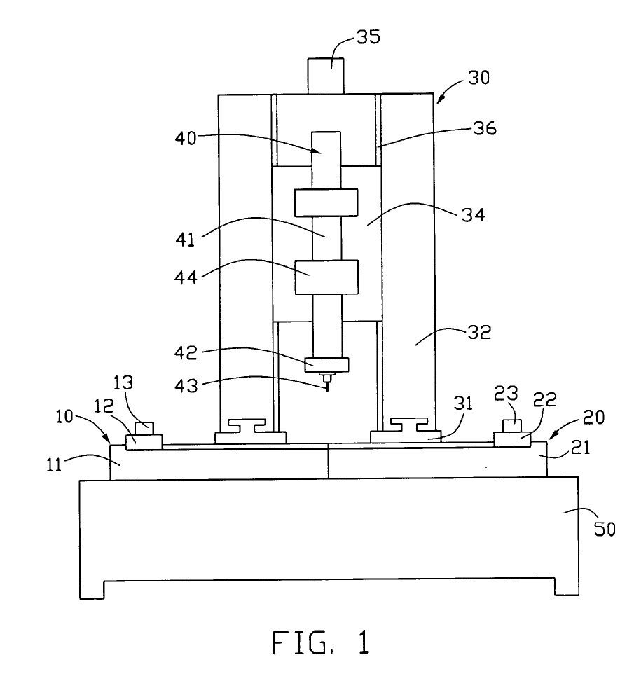

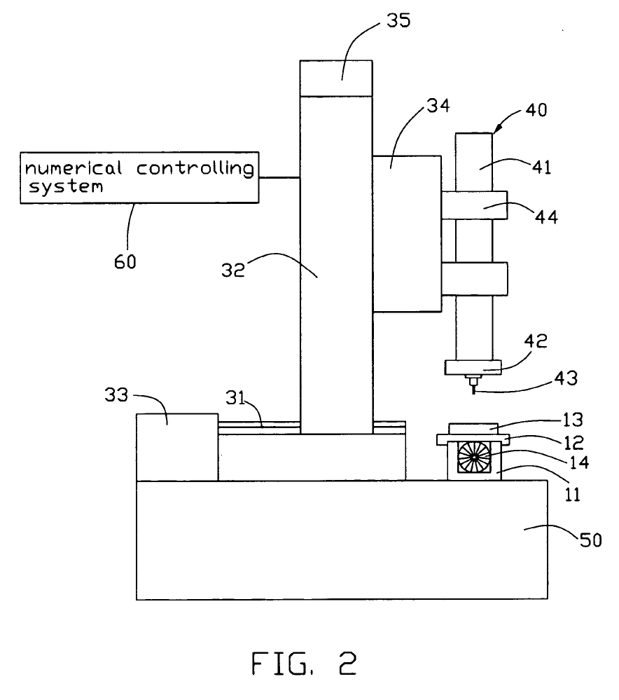

Referring to FIGS. 1 and 2, in a preferred embodiment, an engraving apparatus for engraving workpieces includes a first sliding assembly 10, a second sliding assembly 20, a first driving device 14, a second driving device 30, and a cutting tool assembly 40. In this embodiment, a base 50 is configured for supporting the sliding assemblies 10, 20 and the second driving device 30.

The first sliding assembly 10 includes a first rail 11, a first sliding mechanism 12, and a first worktable 13. The first sliding mechanism 12 is slidably positioned on the first rail 11, and the first worktable 13 is secured on the first sliding mechanism 12. The first worktable 13 is configured for carrying workpieces. The first sliding mechanism 12 is connected to the first driving device 14 to drive the first sliding mechanism 12 to slide on the first rail 11. In this embodiment, the first driving device 14 is a motor.

The second sliding assembly 20 includes a second rail 21, a second sliding mechanism 22, and a second worktable 23. The second sliding mechanism 22 is slidably positioned on the second rail 21, and the second worktable 23 is secured on the second sliding mechanism 22. The second worktable 23 is also configured for carrying workpieces. The second sliding mechanism 22 is also connected to the first driving device 14 to drive the second sliding mechanism 22 to slide on the second rail 21. Understandably, the second sliding mechanism 22 can also be connected to another driving device. In this embodiment, the first rail 11 and the second rail 21 are connected together in alignment.

The second driving device 30 includes a horizontal rail apparatus 31, a sliding carrier 32, and a horizontal motor 33, a sliding block 34, and a perpendicular motor 35. The sliding carrier 32 is slidably positioned on the horizontal rail apparatus 31. The sliding carrier 32 has a perpendicular rail apparatus 36, and the sliding block 34 is slidably positioned on the perpendicular rail apparatus 36. The horizontal motor 33 is connected to the sliding carrier 32 for driving the sliding carrier 32 to move horizontally on the horizontal rail apparatus 31. The perpendicular motor 35 is connected to the sliding block 34 for driving the sliding block 34 to move perpendicularly on the perpendicular rail apparatus 36.

The cutting tool assembly 40 includes a principal axle 41, a cutter fastener 42, and a cutter 43. The principal axle 41 is secured on the sliding block 34 by a bonding belt 44. The cutter fastener 42 is connected to a lower end of the principal axle 41, and the cutter 43 is fastened on the cutter fastener 42. The engraving apparatus further includes a numerical controlling system 60 for controlling the operation of the engraving apparatus.

In use, firstly, two workpieces are separately secured on the first worktable 13 and the second worktable 23. Secondly, the first worktable 13 and the second worktable 23 are moved near the cutter 43 on the first sliding mechanism 12 and the second sliding mechanism 22. Thirdly, the cutter 43 is controlled to engrave the workpiece on the first worktable 13. Fourthly, the first worktable 13 is moved to its original position and the workpiece on it is removed, at the same time, the cutter 43 engraves the workpiece on the second worktable 23. Fifthly, another workpiece secured on the first worktable 13 is moved near to the cutter 43 to be engraved, at the same time, the second worktable 23 is moved to its original position, the engraved workpiece is removed, and new workpiece is secured. The process can be repeated, thus increasing efficiency During the engraving process, the first driving device 14 moves the first sliding mechanism 12 and the second sliding mechanism 22. The numerical controlling system 60 controls the operation of the engraving apparatus.

The engraving apparatus can engrave workpieces on the second worktable whilst the engraved workpiece on the first worktable is being removed. Thus, the engraving apparatus has a higher efficiency and is more practical for mass-use.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. An engraving apparatus for engraving workpieces, comprising:
a sliding assembly including at least one rail and at least two worktables for carrying the workpieces, the worktables being slidably positioned on the rail;
a cutting tool assembly including a cutter; and
a driving mechanism for driving the worktables and the cutting tool assembly.

2. The engraving apparatus as claimed in claim 1, wherein the cutting tool assembly comprises a principal axle and a cutter fastener, the cutter fastener is connected to one end of the principal axle, and the cutter is fastened on the cutter fastener.

3. The engraving apparatus as claimed in claim 1, wherein the driving mechanism includes a first driving device for driving the worktables and a second driving device for driving the cutting tool assembly.

4. The engraving apparatus as claimed in claim 3, wherein the first driving device is a motor.

5. The engraving apparatus as claimed in claim 3, wherein the second driving device includes a horizontal rail apparatus, a sliding carrier slidably positioned on the horizontal rail apparatus, and a motor, the sliding carrier has a perpendicular rail apparatus, and a sliding block slidably positioned on the perpendicular rail apparatus.

6. The engraving apparatus as claimed in claim 5, wherein the cutting tool assembly is secured on the sliding block.

7. The engraving apparatus as claimed in claim 5, wherein the motor is connected to the sliding carrier and the sliding block.

8. The engraving apparatus as claimed in claim 5, wherein the motor drives the sliding carrier to move horizontally, and drives the sliding block to move perpendicularly.

9. The engraving apparatus as claimed in claim 1, wherein the sliding assembly includes two rails and two sliding worktables, and the worktables are each positioned on a separate rail.

10. The engraving apparatus as claimed in claim 1, further comprising a base for supporting the sliding assembly and the driving mechanism.

11. An engraving apparatus for engraving workpieces, comprising:
a sliding assembly including at least one rail and at least two worktables for carrying the workpieces, the worktables being slidably positioned on the rail;
a cutting tool assembly including a cutter;
a first driving device configured for driving the worktables to move between a workpiece engraving position and a workpiece secure/removal position and in a manner that when one of the at least two worktables is in the engraving position, the other is in the secure/removal position; and
a second driving device configured for driving the cutter of the cutting tool to engrave the workpieces.

12. The engraving apparatus as claimed in claim 11, wherein the cutting tool assembly comprises a principal axle and a cutter fastener, the cutter fastener is connected to one end of the principal axle, and the cutter is fastened on the cutter fastener.

13. The engraving apparatus as claimed in claim 11, wherein the second driving device includes a horizontal rail apparatus, a sliding carrier slidably positioned on the horizontal rail apparatus, and a motor, the sliding carrier has a perpendicular rail apparatus, and a sliding block slidably positioned on the perpendicular rail apparatus.

14. The engraving apparatus as claimed in claim 13, wherein the cutting tool assembly is secured on the sliding block.

15. The engraving apparatus as claimed in claim 13, wherein the motor is connected to the sliding carrier and the sliding block.

16. The engraving apparatus as claimed in claim 13, wherein the motor drives the sliding carrier to move horizontally, and drives the sliding block to move perpendicularly.
